(19) United States
(12) Patent Application Publication
(10) Pub. No.: US 2004/0088933 A1
(43) Pub. Date: May 13, 2004

(54) Trim guard

(76) Inventor: Timothy Joe Mayes, Grandview, MO (US)

Correspondence Address: HOVEY WILLIAMS LLP, Suite 400, 2405 Grand, Kansas City, MO, 64108, US

(21) Appl. No.: 10/291,450

(22) Filed: Nov. 8, 2002

(51) Int. Cl. E06B 1/04

(52) U.S. Cl. 52/211

(57) ABSTRACT

Protective guard system that is readily attachable and detachable to and from a variety of sizes and shapes of structures. The guard includes an elongated generally C-shaped body that includes a plurality of ridges for gripping the structure to which it is attached.

### BACKGROUND OF THE INVENTION

1. Field of the Invention

The present invention relates generally to protective guard systems for protecting an object from damage caused by physical contact with another object. In another aspect, the invention concerns an easily attachable and removable protective guard for reducing damage to a fixed finished structure, such as a door frame or a support post, due to contact between the structure and an object being moved past the structure.

2. Discussion of the Prior Art

Individuals and businesses frequently relocate, thereby requiring a multitude of personal belongings and/or business equipment to be moved out of an old space (e.g., residence or office) and into a new space. During the moving process, many valuable finished items (e.g., desks, chairs, tables, etc.) are moved past or through finished structures (e.g., doorways, newel posts, support posts, etc). Inevitably, the moving of heavy and bulky objects past fixed structures will result in damage to the moved object and/or the stationary structure due to inadvertent contact therebetween. As such, companies providing moving services must carry liability insurance to cover the cost of damage occurring during the moving process. Thus, reducing the risk of damage to objects and structures during the moving process would not only minimize the cost of repairing damaged goods, but may also reduce the cost of liability insurance for such moving procedures.

In the past, several protective guards have been offered for protecting door frames from damage caused by contact with objects being moved past the door frame. However, the particular designs of such prior art devices severely limit their versatility. For example, many of the prior art devices were only suitable for use on a certain size and configuration of door frames, and were not suitable for protecting the hinge-side of a swinging door. Further, the prior art devices could only be used on door frames and were not configured to protect other structures in homes and offices such as, for example, support posts, newel posts, and hand rails. A further disadvantage of prior art protective guard devices is that many of such devices had a complex construction which made them expensive to produce.

### OBJECTS AND SUMMARY OF THE INVENTION

Responsive to these and other problems, an important object of the present invention is to provide a protective guard system having a configuration that allows it to be employed on numerous structures that vary greatly in size and shape.

Another object of the invention is to provide a protective guard system having a simple and durable construction that minimizes manufacturing cost and maximizes the useful life of the system.

Still another object of the present invention is to provide a protective guard system that can be easily attached and detached from a structure in a minimal amount of time, with minimal effort, and with no damage to the structure.

Accordingly, in one embodiment of the present invention, there is provided a protective guard mountable on a variety of structures having different shapes and sizes. The guard comprises an elongated body having a generally C-shaped axial cross section. The body includes first and second gripping portions that are adapted to contact the structure when the body is mounted thereon. The gripping portions include a plurality of ridges that extend generally parallel to the direction of elongation of the body.

In another embodiment of the present invention, there is provided a protective guard mountable on a variety of structures having different shapes and sizes. The guard comprises a unitary elongated body integrally formed of a single piece of resilient material and presenting an inner surface that defines a structure-receiving chamber. The body has an opening extending along the length of the body to provide access to the structure-receiving chamber. The inner surface of the body presents first and second sets of lengthwise-extending ridges positioned proximate the opening on opposite sides of the opening. The body is shiftable between a maximum open position and a minimum closed position. The opening is wider when the body is in the maximum open position than when the body is in the minimum closed position. The body is biased toward the minimum closed position. The opening is at least four inches wide when the body is in the maximum open position and the opening is less than one inch wide when the body is in the minimum closed position.

In still another embodiment of the present invention, there is provided a method of protecting a door frame and a generally cylindrical structure. The method comprises the steps of: (a) attaching a first guard to the door frame; and (b) attaching a second guard to the cylindrical structure. The first and second guards have substantially the same configuration.

Other aspects and advantages of the present invention will be apparent from the following detailed description of the preferred embodiment and the accompanying drawing figures.

### BRIEF DESCRIPTION OF THE DRAWING FIGURES

A preferred embodiment of the present invention is described in detail below with reference to the attached drawing figures, wherein:

FIG. 1 is an isometric view of an inventive protective guard system mounted on a door frame;

FIG. 2 is a fragmentary isometric view of a protective guard in the closed position when not mounted on a structure; and

FIG. 3 is a sectional view of the protective guard in an open position mounted on a door frame.

### DETAILED DESCRIPTION OF THE PREFERRED EMBODIMENT

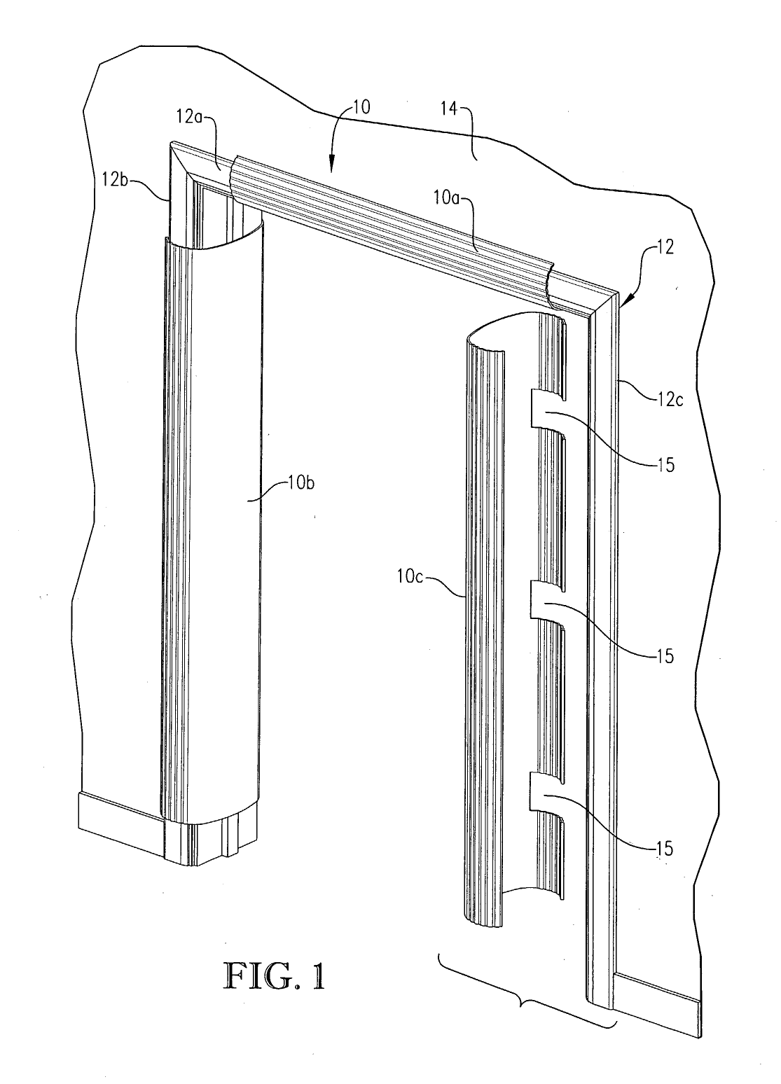

Referring initially to FIG. 1, a protective guard system 10 is illustrated as being partially installed on a door frame 12 that defines a door opening in a wall 14. Protective guard system 10 includes an overhead guard 10a coupled to an overhead portion 12a of door frame 12, a first side guard 10b coupled to a first side portion 12b of door frame 12, and a second side guard 10c illustrated in an assembly view as being positioned for mounting on a second side portion 12c of door frame 12.

Protective guard system 10 can be sold in a kit containing one or more of overhead guard 10a, first side guard 10b, and second side guard 10c. Each guard 10a,b,c generally comprises an elongated body integrally formed of (i.e., extruded from) a single piece of resilient material such as, for example, flexible polyvinyl chloride (PVC) or pliable vinyl. It is preferred for the material from which the body is formed to have a modulus of elasticity (ASTM D790-91) in the range of from about 50,000 to about 500,000 psi, preferably in the range of from about 60,000 to about 200,000 psi, and most preferably in the range of from 80,000 to 150,000 psi, thereby providing an optimum balance of flexibility and stiffness. Each guard 10a,b,c has a generally uniform C-shaped axial cross section. As used herein, the term “axial cross section” shall denote a section taken perpendicular to the axis of elongation of a body. Guards 10a,b,c are adapted to be wrapped at least partly around door frame 12 and exert a compressive force on door frame 12 and/or wall 14. The compressive force exerted by guards 10a,b,c on door frame 12 and/or wall 14 should be of a sufficient magnitude to allow guards 10a,b,c to be self-supporting when mounted on door frame 12.

It is preferred for the length of overhead guard 10a to be in the range of from about 12 to about 36 inches, more preferably in the range of from about 18 to about 30 inches, and most preferably in the range of from 20 to 28 inches. It is preferred for the length of first and second side guards 10b,c to be in the range of from about 48 to about 96 inches, more preferably in the range of from about 60 to about 84 inches, and most preferably in the range of 68 to 78 inches. It is preferred for guards 10a,b,c to have a thickness in the range of from about 0.05 to about 0.5 inches, more preferably in the range of from about 0.075 to about 0.25 inches, and most preferably in the range of from 0.1 to about 0.2 inches. As shown in FIG. 1, second side guard 10c can include a plurality of spaced apart hinge cut-outs 15 that allow guard 10c to be placed on the hinge side 12c of door frame 12. Although FIG. 1 illustrates each guard 10a,b,c as being mountable on door frame 12, the configuration of guards 10a,b,c, described in detail below, allows guards 10a,b,c to be mounted on objects having a wide variety of shapes and sizes (e.g., cylindrical support posts, newel posts, handrails, etc).

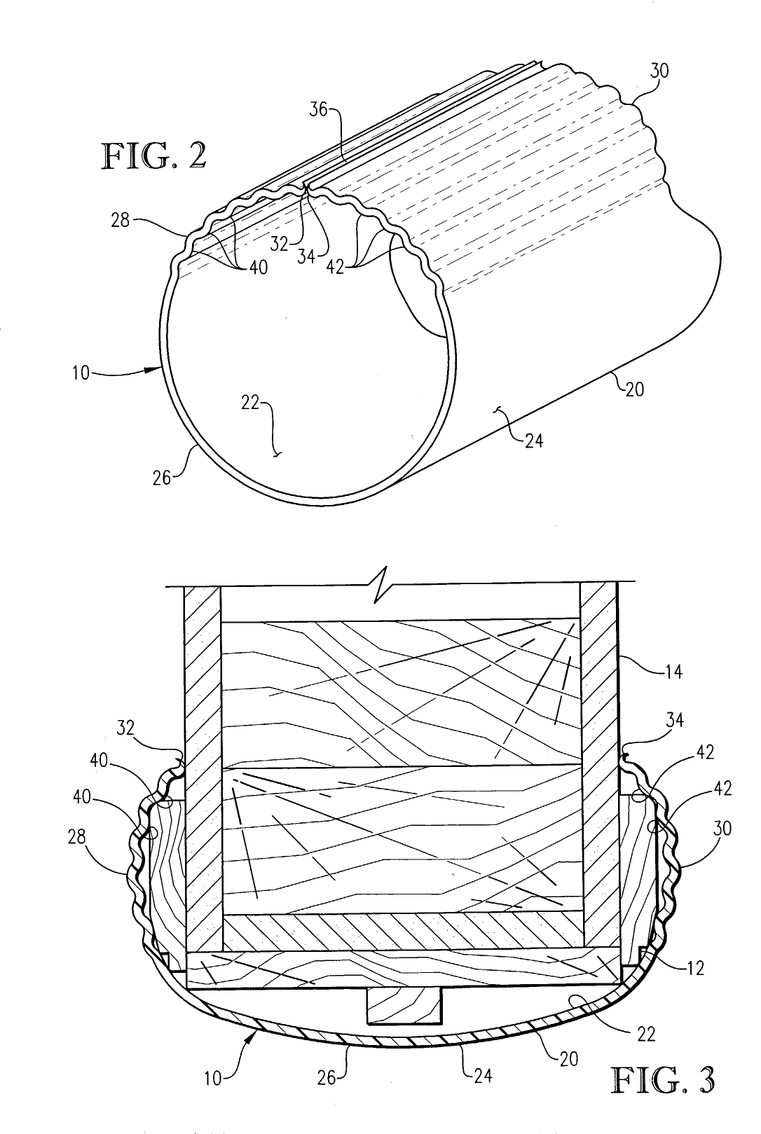

Referring now to FIGS. 2 and 3, protective guard 10 can be shifted between a closed position (shown in FIG. 2) and an open position (shown in FIG. 3) by manual manipulation. When in the closed position, guard 10 has a generally circular or closed C-shaped axial cross section. When in the open position, guard 10 has a generally open C-shaped axial cross section. The configuration of guard 10 provides a bias towards the closed position.

Guard 10 includes an elongated main body 20 that presents an inner surface 22 and an outer surface 24. Body 20 includes a smooth portion 26, a first corrugated portion 28, a second corrugated portion 30, a first edge 32, and a second edge 34. First and second edges 32, 34 preferably extend the entire length of body 20 in a direction that is generally parallel to the direction of elongation of body 20. An opening 36 is defined between first and second edges 32, 34, with the width of opening 36 being adjustable via manual flexing of body 20. When guard 10 is in the closed (i.e., resting) position, it is preferred for the width of opening 36 to be less than about one inch, more preferably less than about 0.5 inches, and most preferably opening 36 is substantially closed with edges 32, 34 contacting and pressing against one another. When guard 10 is in a maximum open (i.e., maximum flexed) position, it is preferred for the width of opening 36 to be at least about four inches, more preferably at least about five inches, and most preferably at least about six inches. Because body 20 is biased towards the closed position, any time body 20 is flexed past its resting position to widen opening 36, first and second edges 32, 34 are poised to exert opposing compressive forces on an object placed therebetween. It is preferred for the magnitude of such opposing compressive force to be sufficient to allow guard 10 to be self-supporting on substantially smooth vertical objects having a width anywhere in the range of two to six inches via contact only between edges 32, 34 and generally parallel spaced apart vertical substantially smooth surfaces of the object. Thus, guard 10 can be used on a variety of objects having a variety of sizes. Because terminal edges 32, 34 contact and exert a compressive force on a finished structure, it is preferred for edges 32, 34 to be rounded to prevent marring of the surface on which guard 10 is mounted. Preferably, the minimum radius of curvature of rounded edges 32, 34 is at least about 0.02 inches, more preferably at least about 0.05 inches, and most preferably at least 0.1 inches.

First and second corrugated portions 28, 30 are disposed adjacent first and second edges 32, 34, respectively. First and second corrugated portions 28, 30 define respective first and second sets of ridges 40, 42 of inner surface 22. Sets of ridges 40, 42 are operable to provide enhanced gripping of the structure on which guard 10 is mounted. Each set of ridges 40, 42 includes a plurality of individual ridges that each extend generally-parallel to first and second edges 32, 34. Preferably, each set of ridges 40, 42 includes at least three individual ridges, more preferably at least four individual ridges, and most preferably at least five individual ridges. It is preferred for each individual ridge to be rounded so as to prevent marring of the surface to which guard 10 is coupled. Preferably, each ridge has a minimum radius of curvature of at least about 0.05 inches, more preferably at least about 0.1 inches, and most preferably at least 0.2 inches. First and second sets of ridges 40, 42 preferably extend inwardly from first and second edges 32, 34 at least one inch, more preferably at least two inches, thereby providing a sufficiently wide gripping surface on each side of opening 36.

Although the portions of outer surface 24 defined by first and second corrugated portions 28,30 include a plurality of ridges, it is preferred for a substantial portion of outer surface 24 to be substantially smooth in order to prevent objects that pass thereby from being “caught up” with guard 10. The smooth portion of outer surface 24 allows objects contacting outer surface 24 to easily slide past guard 10. The smooth portion of outer surface 24 is preferably centered opposite opening 36 and forms at least about 40 percent of the total surface area of outer surface 24, more preferably at least about 50 percent of outer surface 24, and most preferably at least 65 percent of outer surface 24.

As discussed earlier, guard 10 can be mounted on objects having a variety of shapes and sizes. A significant advantage of guard 10 is that it can not only be mounted on door frames, but it can also be mounted on cylindrical objects such as support posts. Guard 10 can be mounted on door frames (or other objects having generally rectangular edges) having a width anywhere in the range of from about two to about six inches. Guard 10 can be mounted on cylindrical structures having an outer diameter anywhere in the range of from about two to about eight inches.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A protective guard mountable on a variety of structures having different shapes and sizes, said guard comprising:
an elongated body having a generally C-shaped axial cross section,
said body including first and second gripping portions adapted to contact the structure when the body is mounted thereon,
each of said gripping portions including a plurality of ridges that extend generally parallel to the direction of elongation of the body.

2. A protective guard according to claim 1,
said body configured to exert a sufficient compressive force on the structure so that the body is self-supporting when mounted on the structure.

3. A protective guard according to claim 1,
said body including first and second generally parallelly extending opposing edges,
said first and second gripping portions being positioned adjacent the first and second edges, respectively.

4. A protective guard according to claim 3,
each of said edges and each of said ridges being rounded.

5. A protective guard according to claim 3,
said body being shiftable between a closed position and an open position,
said edges being spaced farther from one another when the body is in the open position than when the body is in the closed position.

6. A protective guard according to claim 5,
said body being biased toward the closed position.

7. A protective guard according to claim 6,
said body being integrally formed of a single piece of resilient material.

8. A protective guard according to claim 6,
said body being operable to press the edges against one another when the body is in the closed position.

9. A protective guard according to claim 1,
each of said gripping portions including at least three ridges.

10. A protective guard according to claim 1,
said gripping portions being corrugated.

11. A protective guard according to claim 1,
said body including a smooth portion positioned between the gripping portions and
presenting a substantially smooth outer surface.

12. A protective guard mountable on a variety of structures having different shapes and sizes, said guard comprising:
a unitary elongated body integrally formed of a single piece of resilient material and presenting an inner surface that defines a structure-receiving chamber,
said body having an opening extending along the length of the body and providing access to the structure-receiving chamber,
said inner surface presenting first and second sets of lengthwise-extending ridges positioned proximate the opening on opposite sides of the opening,
said body being shiftable between a maximum open position and a minimum closed position,
said opening being wider when the body is in the maximum open position than when the body is in the minimum closed position,
said body being biased towards the minimum closed position,
said opening being at least four inches wide when the body is in the maximum open position,
said opening being less than one inch wide when the body is in the minimum closed position.

13. A protective guard according to claim 12,
said body having a generally C-shaped axial cross section when in the maximum open position.

14. A protective guard according to claim 13,
said body having a generally circular cross-section when the body is in the minimum closed position.

15. A protective guard according to claim 12,
said body presenting an outer surface that includes a substantially smooth portion,
said substantially smooth portion forming at least 50 percent of the outer surface,
said substantially smooth surface being centered generally opposite the opening.

16. A protective guard according to claim 15,
said substantially smooth surface forming at least 65 percent of the outer surface.

17. A protective guard according to claim 16,
said sets of ridges being formed by corrugated portions of the body,
said smooth portion of the outer surface extending between the corrugated portions.

18. A protective guard according to claim 12,
each set of ridges including at least three individual ridges,
each set of ridges extending at least one inch in from the opening.

19. A protective guard according to claim 12,
each set of ridges including at least four individual ridges,
each individual ridge being rounded with a minimum radius of curvature of at least 0.05 inches.

20. A protective guard according to claim 12,
said opening being less than 0.5 inches wide when the body is in the minimum closed position.

21. A method of protecting a door frame and a generally cylindrical structure, said method comprising the steps of:
(a) attaching a first guard to the door frame; and
(b) attaching a second guard to the cylindrical structure,
said first and second guards having substantially the same configuration.

22. A method according to claim 21,
said first and second guards each including an elongated resilient body having a generally C-shaped axial cross section.

23. A method according to claim 22,
said support structure having an outer diameter within the range of from about two to about eight inches.
